(19) United States
(12) Patent Application Publication
(10) Pub. No.: US 2006/0102427 A1
(43) Pub. Date: May 18, 2006

(54) Lubricant supply unit

(76) Inventors: Ching-Shan Wu, Longjing Hsiang (TW); Kuo-Jung Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/986,114

(22) Filed: Nov. 12, 2004

(51) Int. Cl. F16C 17/00

(52) U.S. Cl. 184/5

(57) ABSTRACT

A lubricant supply unit has a casing and a rear seal. The rear seal is mounted on the casing in fluid-tight matter. The casing has four tapered paths defined through the casing. Multiple porous fillings are fitted into the casing. The porous filling near the rear seal has spike protrusions extended into the tapered paths and in contact with a track shaft. Each spike protrusion of the porous filling is compressed by the respective tapered path so that the density of each spike protrusion becomes greater than density of the rest of the porous filling. Therefore, when the lubricating oil inside the porous filling is flowing out of the porous fillings via the tapered paths, flow velocity and amount of the lubricating oil are slow and stable. The rear seal effectively seals a joint between the cover and the casing.

### BACKGROUND OF THE INVENTION

1. Field of the Invention

This invention relates to a lubricant supply unit for coating the surface of a track shaft with lubricant in a linear motion apparatus, and more particularly to a lubricant supply unit to provide stable lubrication and leakage proof functions when lubricating the track shaft and keeping the track shaft clean.

2. Description of Related Art

With reference to FIG. 7, a linear motion apparatus includes a sliding base (50) and two lubricant units respectively mounted on opposed sides of the base (50) (only one is shown in the accompany drawing).

The sliding base (50) is a U-shaped block and has a mounting surface, a proximal end, a distal end, a tunnel (not numbered) and multiple ball grooves (51). The ball grooves (51) are formed along opposed side walls of the tunnel of the sliding base (50) and receive multiple balls (not shown). The lubricant units are respectively mounted at the proximal end and the distal end of the sliding base (50).

Each lubricant unit has a casing (60), lubricant sponges (62) and a cover (63). The casing (60) is a U-shaped block and has a front opening, a tunnel, a lubricant reservoir (61) and four cutouts (611). The lubricant reservoir (61) is formed on the casing (60). The cutouts (611) are located at the tunnel and formed through the casing (60). With reference FIGS. 7 and 8, the lubricant sponges (62) are partially received in the lubricant reservoir (61) and extend out from the cutouts (611) to the inner tunnel.

The cover (63) is mounted on the front opening of the casing (60) to seal the front opening of the casing (60). The cover (63) is a U-shaped plate corresponding to the configuration of the casing (60).

The linear motion apparatus is received on a track shaft (70). An object such as a table, is mounted on a mounting surface of the sliding base (50). The lubricant sponge (62) is saturated with a lubricant drawn from the lubricant reservoir (61) by means such as capillary action. With the reciprocation of the linear motion apparatus on the track shaft (70), each lubricant sponge (62) is in contact with the track shaft (70) and lubricates the track shaft (70) and the balls in the sliding base (50). However, the lubricant sponge is not able to control an amount of lubricating oil provided to lubricate the track shaft (70). Furthermore, the lubricating oil leaks between the casing (60) and the cover (63). Thus, the track shaft (70) receives an excessive amount of oil and this results in wastage of oil, over-frequent re-supply of the lubricant reservoir (61), and the excess oil on the track congeals with dust, etc. in the environment, as well as causing an unsightly appearance. The track shaft (70) can be set up in several dispositions, such as parallel or vertical to a ground. When the linear motion apparatus is moving on the track shaft (70), gravity causes the lubricating oil to concentrate at a certain area of the lubricant sponge (62) whereby the track shaft (70) can not receive enough lubricating oil from the lubricant sponge (62).

When the lubricating oil is exhausted, the lubricant units are disassembled from the linear motion apparatus. The lubricant sponge (62) is replaced or the reservoir is filled with lubricating oil. The above drawbacks highlight the need to improve the present supply unit.

It is noted that the lubricant units have problems in the control of the amount of lubricating oil supplied to the track shaft (70), the lubricating oil leakage and is not very convenient to re-supply.

To overcome the shortcomings, the present invention provides a lubricant supply unit to mitigate the aforementioned problems.

### SUMMARY OF THE INVENTION

The primary objective of the present invention is to provide an improved lubricant supply unit that avoids lubricating oil leakage and provides good flowing velocity, and the amount of the lubricating oil is appropriate to keep a track shaft clean yet lubricated.

The lubricant supply unit has a casing and a rear seal. The rear seal is mounted on the casing in fluid-tight manner. The casing has four tapered paths defined through the casing. Multiple porous fillings are fitted into the casing. The porous filling near the rear seal has spike protrusions respectively extended through the tapered paths for contact with a track shaft. Each protrusion of the porous filling is compressed by the respective tapered path so that the density of each spike protrusion becomes greater than the density of the rest of the porous filling. Therefore, when the lubricating oil inside the porous filling flows out of the porous filling via the tapered paths, flow velocity and amount of the lubricating oil are appropriate due to the change of the density of the protrusion of the porous filling. The rear seal provides a particularly effective fluid-tight joint between the casing and the cover such that leaks therebetween are eliminated.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a lubricant supply unit in accordance with the present invention;

FIG. 2 is a perspective view of a lubricant supply unit mounted on a sliding base in FIG. 1;

FIG. 3 is an operational front view in partial section of the lubricant supply unit in FIG. 1;

FIG. 4 is an operational front view in partial section of a pin rotated in a rod;

FIG. 5 is an operational front view in partial section of a pin rotated in a rod in FIG. 4;

FIG. 6 is an operational front view in partial section of a second embodiment of the lubricant supply unit in accordance with the present invention;

FIG. 7 is an exploded perspective view of a conventional linear motion apparatus in accordance with the prior art; and

FIG. 8 is an operational front view in partial section of the lubricant unit in accordance with the prior art.

### DETAILED DESCRIPTION OF THE PREFERRED EMBODIMENT

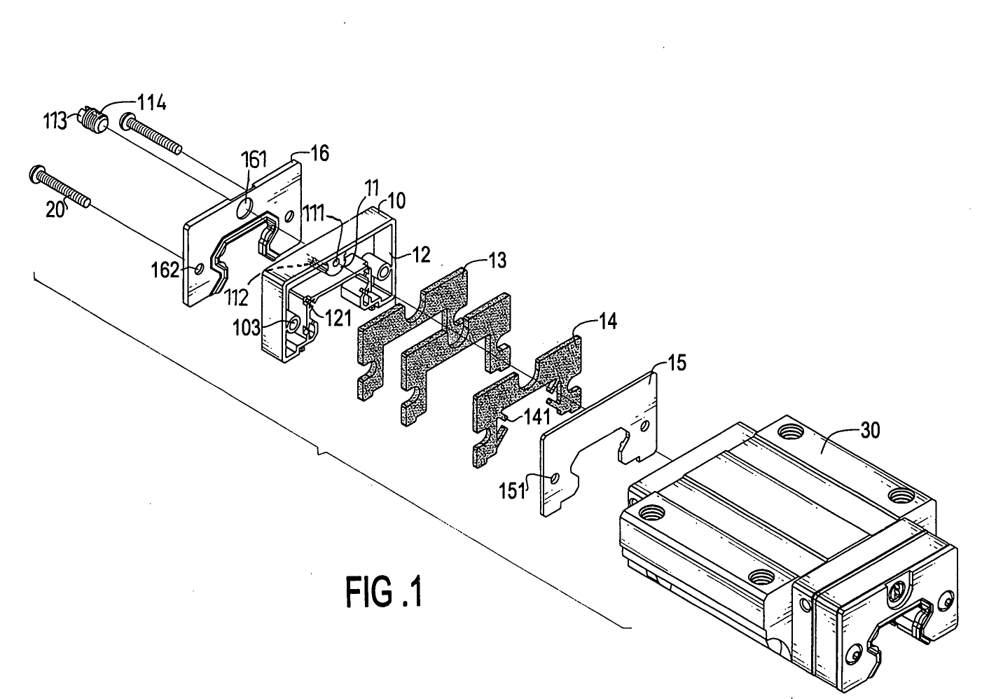

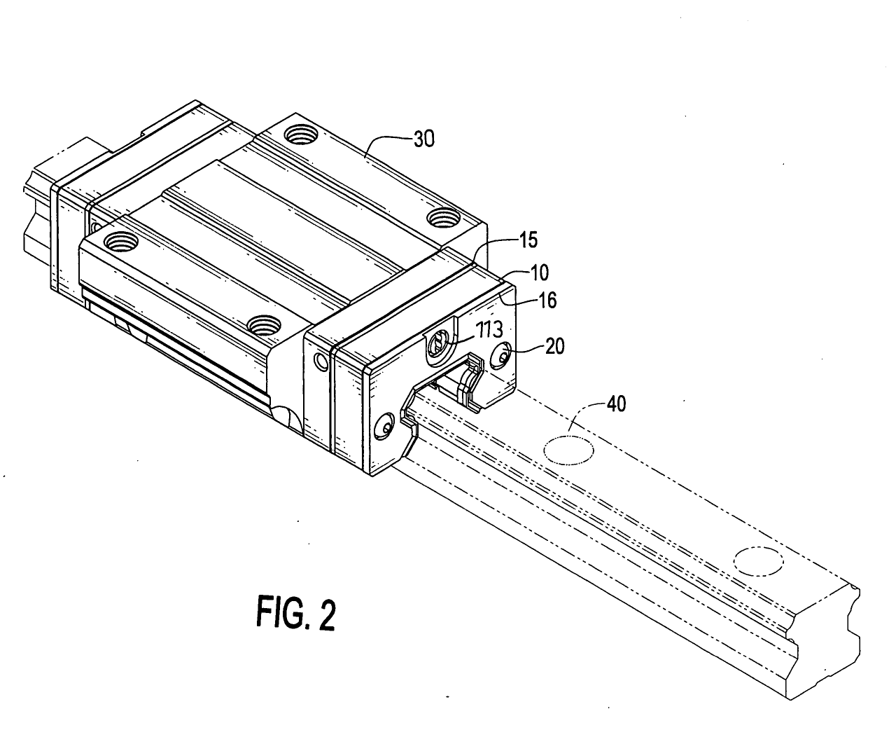

With reference to FIGS. 1 and 2, the lubricant supply unit in accordance with the present invention includes a casing (10), a rear seal (15) and a front cover (16).

The casing (10) is a U-shaped block and has a front surface, a rear opening, a tunnel, a lubricant reservoir (12), a rod (11), four tapered paths (121), two holes (101), and multiple porous fillings (13, 14). With reference to FIGS. 2 and 5, the lubricant reservoir (12) is defined in the casing (10) and communicated with the rear opening. The rod (11) is defined within the lubricant reservoir (12) and has a passage (111) defined through the rod (11). The passage (111) has two side holes (112) transversely defined through the rod (11) and opposite to each other.

A pin (113) is rotatably inserted into the passage (111) of the rod (11) and has two L-shaped holes (114) formed through the pin (113) and selectively communicated with the side holes (112) of the rod (11).

The tapered paths (121) are defined through the casing (10) to communicate with the tunnel. The holes (101) are formed through the casing (10). The porous fillings (13, 14) are fitted tightly into the lubricant reservoir (12).

The rear seal (15) is mounted on the rear opening of the casing (10) in a fluid-tight manner. The rear seal (15) has through holes (151) formed through the rear seal (15) and which correspond to the holes (101) of the casing (10).

It is to be noted that the porous filling (14) near the rear seal (15) has spike protrusions (141) respectively extended into the tapered paths (121) of the casing (10) and protruding into the tunnel.

The front cover (16) is located at the front surface of the casing (10) and has multiple through holes (161, 162) defined through the front cover (16) and which correspond to the passage (111) of the rod (11) and holes (101) of the casing (10). Two bolts (20) respectively extend through the holes (162) of the front cover (16), the holes (101) of the casing (10) and the through holes (151) of the rear seal (15) to mount the lubricant supply unit onto a sliding base (30) of a linear motion apparatus.

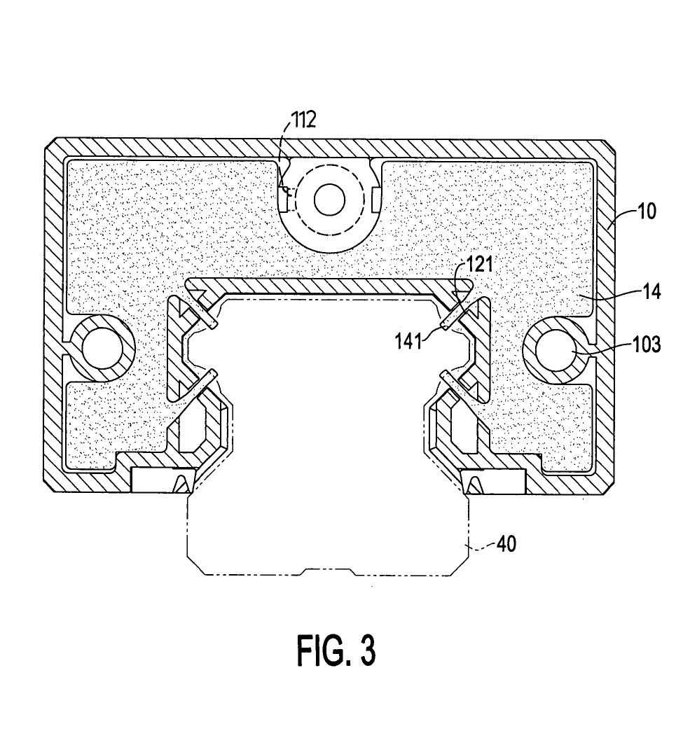

With further reference to FIG. 3, after the porous filling (14) is fitted into the lubricant reservoir (12), the spike protrusions (141) of the porous filling (14) are respectively received in the tapered paths (121). Due to the tapered configuration of the paths (121), the dimensions of voids within the porous filling (14) are changed. That is, because the porous filling (14) is received in the lubricant reservoir (12) with a specific clearance while each spike protrusion (141) is force-fitted in the respective tapered path, the density of each spike protrusion (141) becomes greater than in the rest of the porous filling (14). Therefore, when the lubricating oil inside the porous filling (14) is flowing out of the porous filling (14) via the tapered paths (121), flow velocity and amount of the lubricating oil are slow and stable due to the change of the density of between the spike protrusions (141) and the remainder of the porous filling (14).

Consequently, when tips of the spike protrusions (141) are in contact with a track shaft (40), the flow velocity and amount of the lubricating oil are slow and stable so the track shaft (40) receives enough lubricating oil. Dust and waste materials do not become attracted and attached to the track shaft (40) because excessive oil residue on the shaft is eliminated. The rear seal (15) is mounted on the rear opening of the casing (10) in fluid-tight manner whereby the lubricating oil is not able leak from the casing (10) to outside. Thus, the area around the track shaft (40) is neat and clean in appearance, as well as ensuring the effective operation of the linear motion assembly.

Because the density of the parts (141) of the porous filling (14) varies, so the spike protrusions (141) of the porous filling (14) having capillary attraction to lubricate the track shaft (40) can be set up parallel or vertical to the ground.

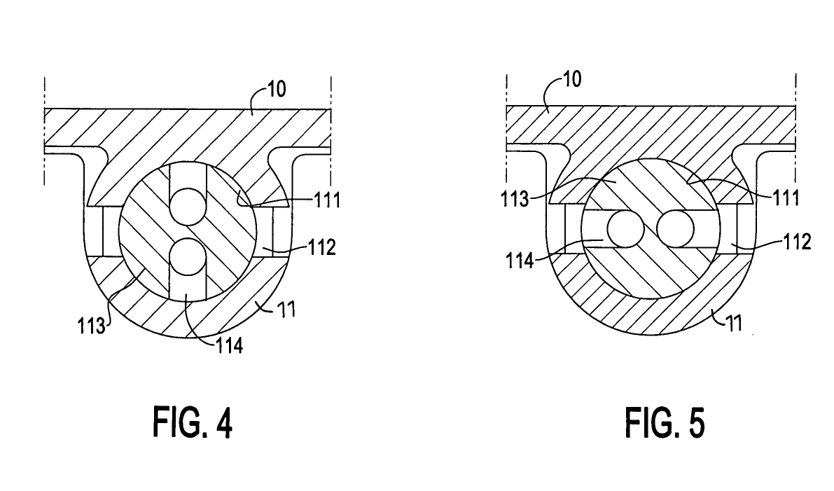

With reference to FIGS. 4 and 5,when the lubricating oil inside the casing (10) is exhausted, the pin (113) is rotated to make L-shaped holes (114) of the pin (113) correspond to the side holes (112) of the rod (11). A re-fueling tool such as a hypodermic needle, is able to inject the lubricating oil through the L-shaped holes (114) of the pin (113) and the side holes (112) of the rod (11) and into the lubricant reservoir (12) of the casing (10). Thus, it is very convenient to refuel the casing (10).

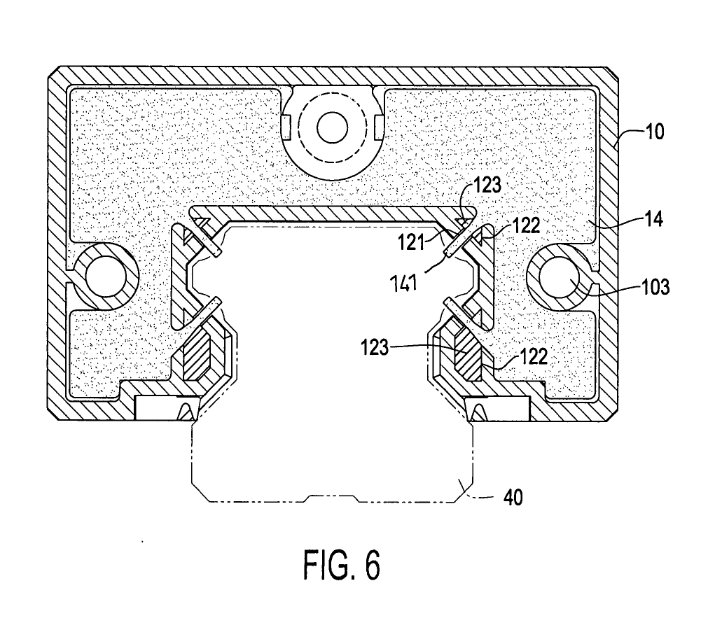

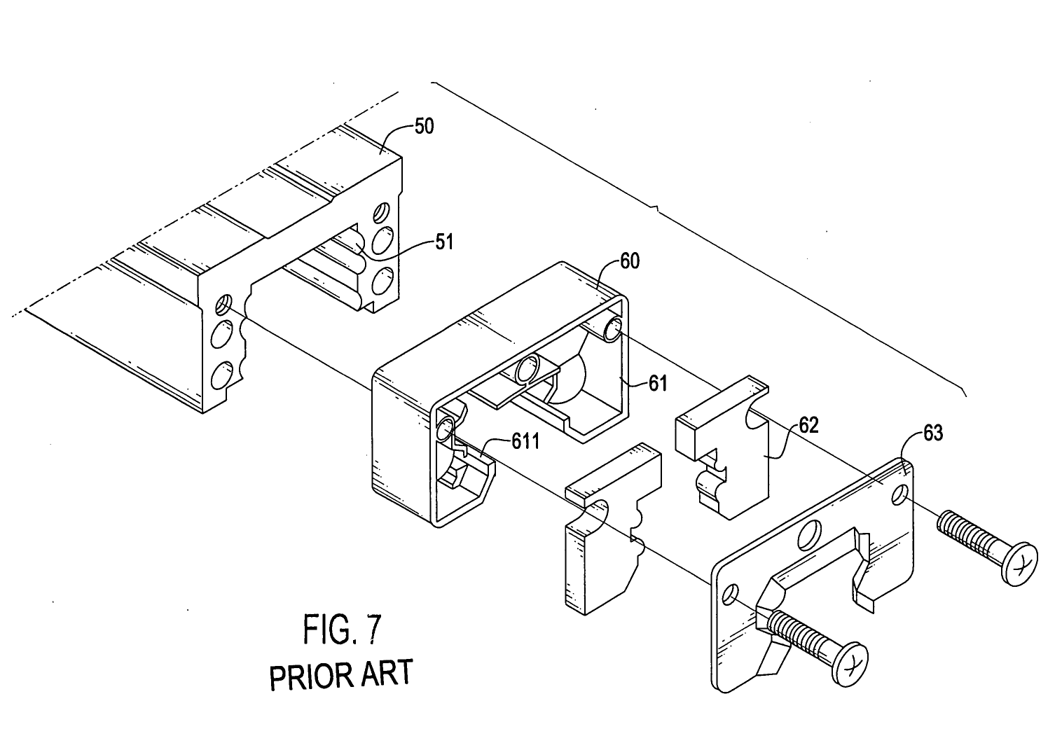

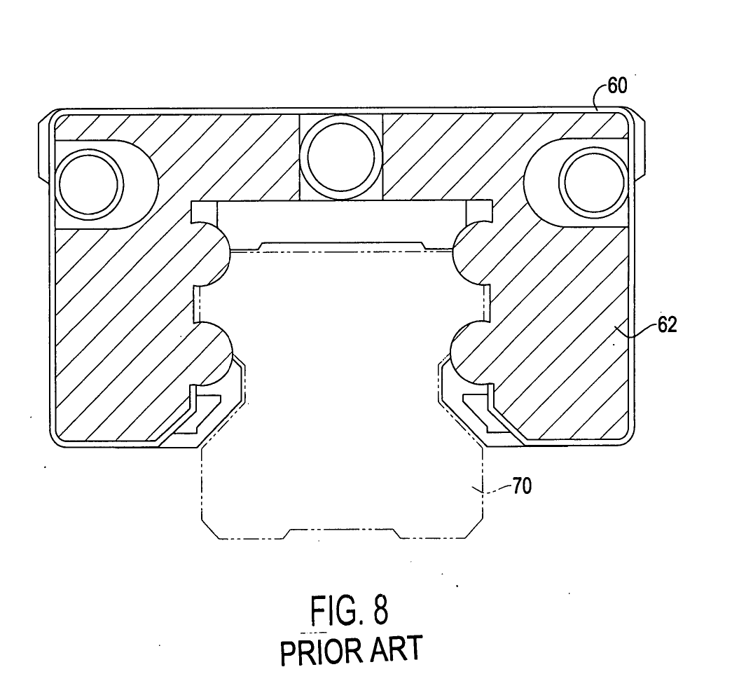

With reference to FIG. 6, in a second embodiment of the lubricating supply unit, multiple receiving spaces (122) are defined in the casing (10). Each receiving space (122) corresponds to and communicates with the respective tapered path (121) to receive therein inserts (123) such as silica gel. The inserts (123) of the receiving spaces (122) also compress the spike protrusions (141) of the porous filling (14) to cause a density of the spike protrusions (141) to be different from that in the rest of the porous filling (14).

In conclusion, the density of the spike protrusions (141) is greater than the density of the rest of the porous filling (14) so the flow velocity and amount is slow and stable. Furthermore, gravity is not able to effect the lubricant supply unit in the lubrication of the track shaft (40), no matter whether the track shaft (40) is parallel or vertical to the ground. It is also easy to refuel the casing (10). The area of the track shaft (40) may be kept clean and the track shaft (40) has an appropriate amount of the lubricating oil.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A lubricant supply unit comprises:
a casing having
a rear opening;
a tunnel;
a lubricant reservoir defined in the casing and communicated with the rear opening;
at least one porous filling fitted into the lubricant reservoir and each having
a body having at least one spike protrusion extending out of the body to be extended into the lubricant reservoir;
at least one tapered path defined through the casing to communicate with the tunnel; and
a rear seal mounted on the rear opening of the casing in a fluid-tight manner;
wherein the at least one porous filling abuts the rear seal and the at least one spike protrusion is compressively extended into the at least one tapered path and a tip of the at least one spike protrusion protrudes into the tunnel of the casing, whereby a density of the at least one spike protrusion is increased by compression from the at least one tapered path, such that the density of the spike protrusion is greater than the body of the porous filling so as to increase resistance for slowing down lubricating oil flow velocity.

2. The lubricant supply unit as claimed in claim 1, wherein the casing has two holes formed through the casing,
the rear seal has through holes formed through the rear seal and corresponded to the holes of the casing.

3. The lubricant supply unit as claimed in claim 2, wherein at least one receiving space is defined in the casing, the at least one receiving space corresponds to and communicates with the at least one tapered path of the casing to receive therein an insert.

4. The lubricant supply unit as claimed in claim 3, wherein the casing has a front surface, a front cover located at the front surface of the casing and having multiple through holes formed through the front cover and corresponded to the passage of the rod and holes of the casing.

5. A lubricant supply unit comprises:
a casing having
a rear opening;
a lubricant reservoir defined in the casing and communicated with the rear opening;
a rod defined within the lubricant reservoir and having
a passage defined through the rod and having
two side holes defined through the rod and opposite to each other;
a pin rotatably inserted in the passage of the rod and having
two L-shaped holes formed through the pin and selectively communicated with the side holes of the rod;
a tunnel;
at least one tapered path defined through the casing to communicate with the tunnel; and
at least one porous filling fitted into the lubricant reservoir and each having
a body having at least one spike protrusion extending out of the body to be extended into the lubricant reservoir;
at least one tapered path defined through the casing to communicate with the tunnel; and
a rear seal mounted on the rear opening of the casing in a fluid-tight matter;
wherein the at least one porous filling abuts the rear seal and the at least one spike protrusion is compressively extended into the at least one tapered path and a tip of the at least one spike protrusion protrudes into the tunnel of the casing, whereby a density of the at least one spike protrusion is increased by compression from the at least one tapered path, such that the density of the at least one spike protrusion is greater than the body of the at least one porous filling so as to increase resistance for slowing down lubricating oil flow velocity,
whereby, when the two L-shaped holes are in communication with the side holes of the rod, lubricating oil is re-supplied to the lubricant reservoir and when the two L-shaped holes are mis-aligned with the two side holes of the rod, re-supply of lubricating oil is blocked.

6. The lubricant supply unit as claimed in claim 5, wherein the casing has two holes formed through the casing,
the rear seal has through holes formed through the rear seal and corresponded to the holes of the casing.

7. The lubricant supply unit as claimed in claim 6, wherein at least one receiving space is defined in the casing, the at least one receiving space corresponds to and communicates with the at least one tapered path of the casing to receive therein an insert.

8. The lubricant supply unit as claimed in claim 7, wherein the casing has a front surface, a front cover located at the front surface of the casing and having multiple through holes formed through the front cover and corresponded to the passage of the rod and holes of the casing.
